(19) United States
(12) Patent Application Publication
(10) Pub. No.: US 2002/0198794 A1
(43) Pub. Date: Dec. 26, 2002

(54) Inventory management system for determining suggested part stocking levels for a vehicle dealer

(76) Inventors: Edward P. Williams, Oxford, MI (US); Idris Godhrawala, Troy, MI (US); James H. Untiedt, Shelby Township, MI (US); Todd C. DeLong, Fenton, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 09/886,796

(22) Filed: Jun. 21, 2001

(51) Int. Cl. G06F 17/60

(52) U.S. Cl. 705/28

(57) ABSTRACT

A method is provided for determining a suggested vehicle part order for a vehicle retailer by a vehicle part inventory management system. The method includes the steps of: (a) receiving from the vehicle retailer at least one of a target fill rate and a target inventory investment; (b) accessing part demand forecast information for the vehicle retailer; (c) accessing part cost information; and (d) determining a suggested part order for the vehicle retailer based on the part demand forecast information and the part cost information in view of the target fill rate or the target inventory investment input by the vehicle retailer.

### BACKGROUND OF THE INVENTION

1. Field of the Invention

The present invention relates generally to an integrated inventory management system and, more particularly, to a computer-implemented method for determining suggested part stocking levels for a vehicle dealer.

2. Discussion

Research performed by vehicle manufactures has shown that vehicle dealers have generally exercised inadequate or inconsistent inventory control practices. These practices have frequently resulted in poor vehicle parts availability, excessive field obsolescence and ineffective inventory investment. In addition, the inconsistency with which the vehicle dealers conducted their parts business also fed back through the supply chain and adversely affected the efficiency and responsiveness of the vehicle parts suppliers.

In order to reduce and/or eliminate these impacts, vehicle manufactures determined that there was a need to gain system-wide vehicle parts inventory “visibility” for the vehicle manufactures and their dealers. Thus, an integrated vehicle part inventory management system was developed to meet this need. The integrated inventory management system includes a parts locator feature, an automated dealer-to-dealer referral feature, a forecasting and part level setting feature, a suggested stocking level feature, a suggested material return feature, and some improved reporting features. In this way, the vehicle manufactures expected to improve vehicle dealer part inventories with increased parts mix, improve part fill rates, reduce field obsolescence and improve overall performance throughout the supply chain.

Therefore, it is desirable to provide a part inventory management system for determining suggested part stocking levels for a vehicle dealer. In particular, the system should provide an optimal vehicle part mix by minimizing a dealer's inventory investment given an overall target fill rate or maximizing the dealer's fill rate given an overall target inventory investment level. In addition, at least a portion of the suggested stocking levels for the vehicle dealer may account for regional part sales information.

### SUMMARY OF THE INVENTION

In accordance with the teachings of the present invention, a method is provided for determining suggested vehicle part stocking levels for a vehicle dealer by a vehicle part inventory management system. The method includes the steps of: (a) receiving from the vehicle dealer at least one of a target fill rate and a target inventory investment; (b) accessing part demand information for the vehicle dealer; (c) accessing part cost information; and (d) determining a suggested part stocking level for the vehicle dealer based on the part demand information and the part cost information in view of the target fill rate or the target inventory investment input by the vehicle dealer.

Additional benefits and advantages of the present invention will become apparent to those skilled in the art to which this invention relates from a reading of the subsequent description of the preferred embodiment and the appended claims, taken in conjunction with the accompanying drawings.

### BRIEF DESCRIPTION OF THE DRAWINGS

FIG. 1 is a diagram depicting the distributed computing platforms for a part inventory management system embodying aspects of the present invention;

FIG. 2 is a block diagram showing the basic components of the part inventory management system residing at the vehicle dealer in accordance with the present invention;

FIG. 3 is a flowchart illustrating a preferred embodiment of the forecasting process as employed by the inventory part management system of the present invention;

FIG. 4 is a flowchart illustrating a preferred embodiment of the optimization process as employed by the inventory part management system of the present invention;

FIGS. 5A and 5B are an exemplary objective function input screen and an exemplary optimization summary screen, respectively, that may be employed by the dealer workbench of the present invention; and

FIG. 6 is a flowchart illustrating a preferred embodiment of the advanced stocking process as employed by the inventory part management system of the present invention.

### DETAILED DESCRIPTION OF THE PREFERRED EMBODIMENT

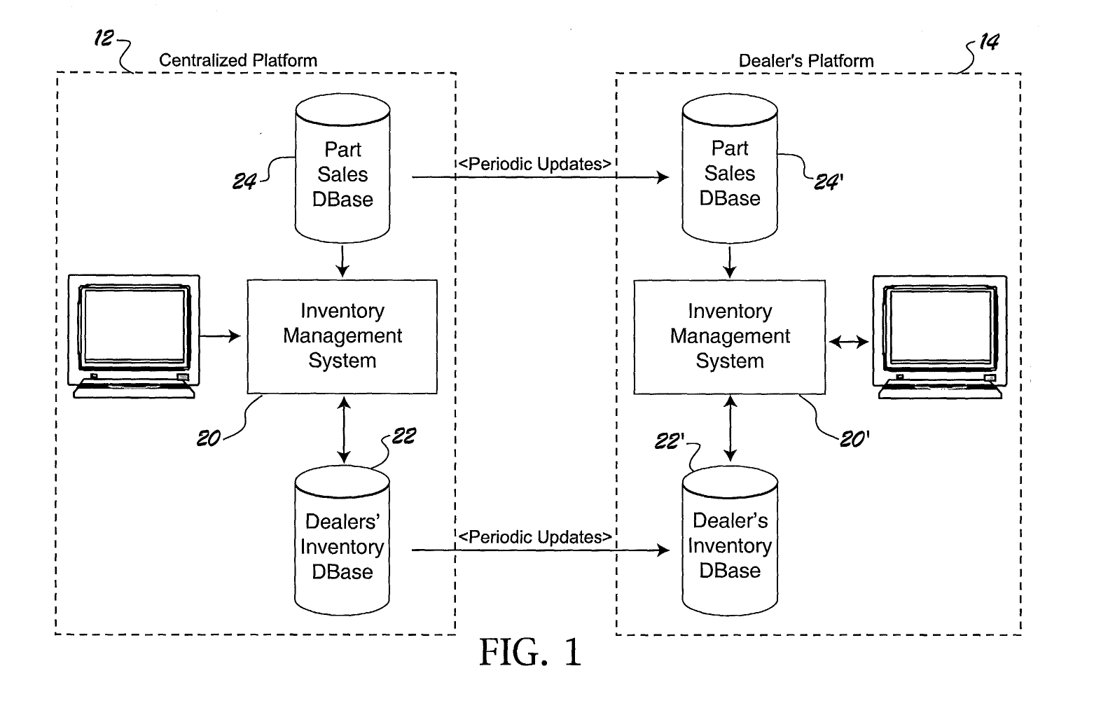

A part inventory management system 10 embodying aspects of the present invention is depicted in FIG. 1. The part inventory management system 10 is distributed between a centralized computing platform 12 and the computing platform 14 residing at each vehicle dealer. In a preferred embodiment, the manufacturer's computing platform 12 and the computing platform for each dealer 14 are interconnected by a satellite communication link. However, as will be apparent to one skilled in the art, the computing platforms 12 and 14 may also be able to communicate using other types of communication links. For illustration purposes, the centralized computing platform 12 is owned and operated by the vehicle manufacturer. Although a vehicle parts supplier is typically the vehicle manufacturer, it is readily understood that in other industries the parts supplier may be independent from the original equipment manufacturer.

The centralized computing platform 12 includes a centralized inventory management system 20, a dealer inventory database 22, and a part sales database 24. The dealer inventory database 22 is used to store part inventory information for a plurality of vehicle dealers; whereas the part sales database 24 is used to store part sales information for a plurality of vehicle dealers. In one aspect of the invention, the centralized inventory management system 20 may compute suggested part stocking levels for one or more of the vehicle dealers based on regional part sales information.

At least a portion of the inventory management system 20′ also resides on a computing device at the vehicle dealer. This portion of the inventory management system 20′ is used by a dealer to manage their local part inventory. A dealer inventory database 22′ and a part sales database 24′ are provided for storing part inventory information and part sales information, respectively, for that particular dealer. The part inventory information and part sales information for a given dealer is periodically uploaded (e.g., on a weekly or nightly basis) to the corresponding centralized database residing on the manufacture's computing platform 12.

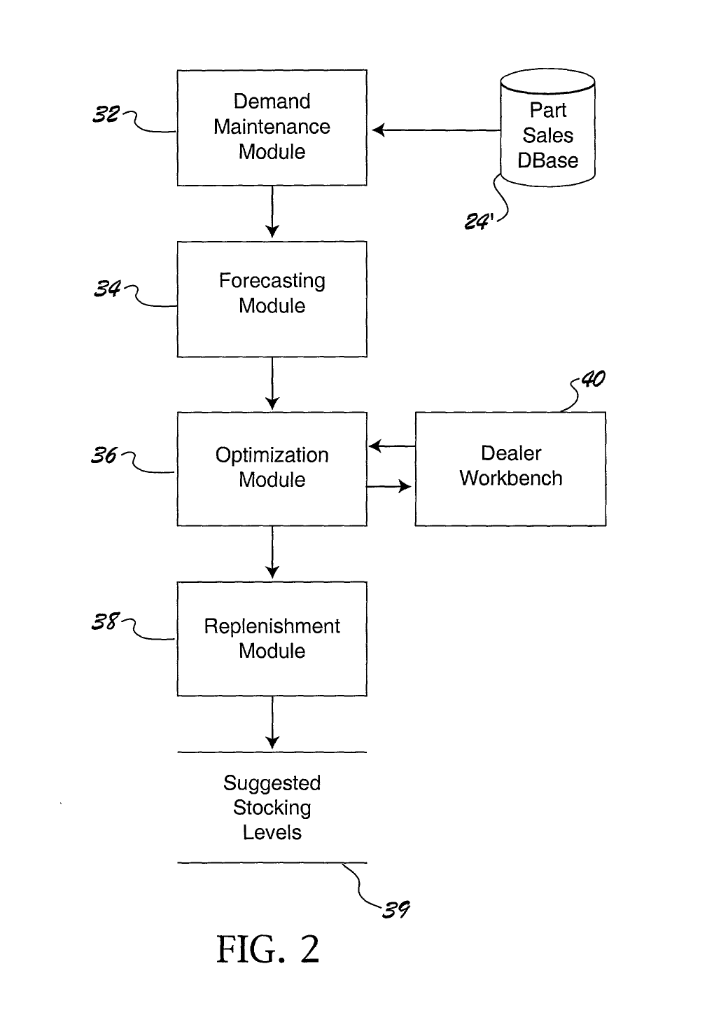

The inventory management system 20′ is further described in conjunction with FIG. 2. The inventory management system 20′ generally includes a part demand maintenance module 32, a forecasting module 34, an optimization module 36, a replenishment module 38, and a dealer workbench module 40. In accordance with the present invention, the inventory management system 20′ determines suggested part stocking levels 39 for a dealer in view of an overall target fill rate or an overall target inventory investment level as provided by the dealer.

More specifically, the part demand maintenance module 32 begins by extracting sales history information from the part sales database 24′. A forecasting module 34 uses the sales history information to calculate a demand forecast for each part. The demand forecast information serves as input to the optimization module 36. The optimization module 36 then attempts to minimize a dealer's inventory investment given an overall target fill rate or to maximize the dealer's fill rate given an overall target inventory investment level. The optimization module 36 outputs an optimal part mix recommendation for the dealer. Lastly, the replenishment module 38 converts the output from the optimization module 36 into suggested part stocking levels for the dealer.

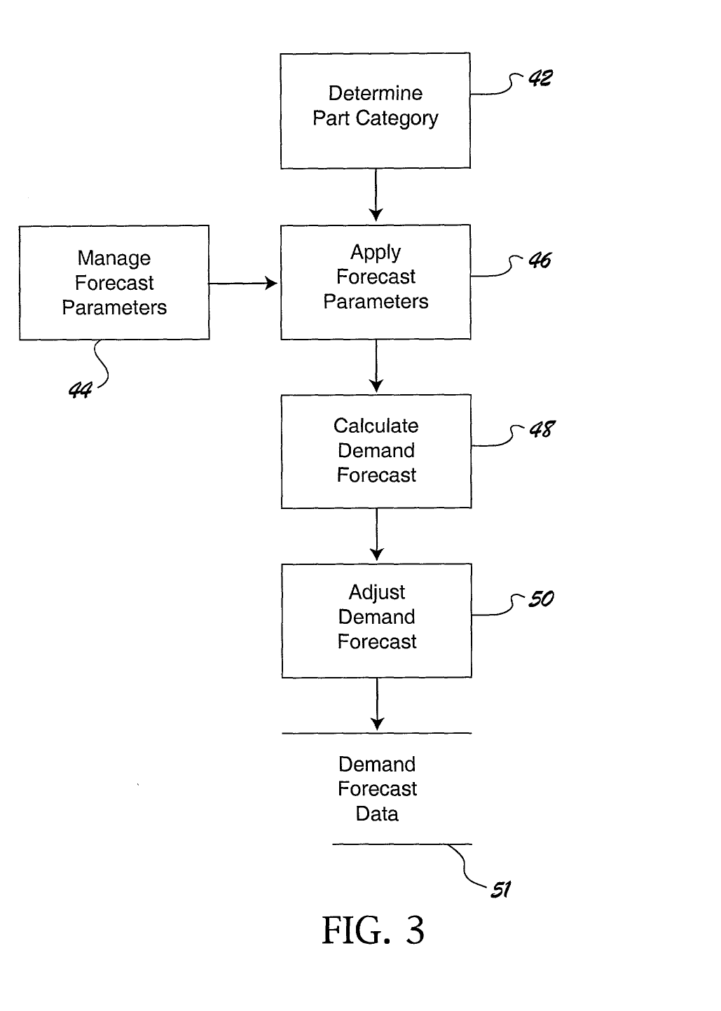

FIG. 3 provides a flowchart for the forecasting process as implemented by the forecasting module 34. Initially, each part is categorized 42 based on the historical demand for the part. In a preferred embodiment, each part is categorized as either a high volume or low volume part. For instance, a part with an average demand greater than some predefined threshold (e.g., one unit per week) is defined as a high volume part; whereas a part with an average demand less than or equal to the threshold is defined as a low volume part. For illustration purposes, the part demand may be equated to prior part sales as retrieved from the part sales database 24′. To the extent available, part demand may also be defined to include lost sales information for a given part. It is envisioned that other demand categories may also be incorporated into the forecasting process. For instance, a part with sporadic demand may be classified as a lumpy volume part. In any event, the part demand category dictates how the demand forecast is calculated for the part.

Forecasting parameters may be used by the vehicle manufacturer to manage the calculation of demand forecast 44. For instance, the manufacturer may define conditions by which the demand forecast calculation is bypassed for a particular part. In other instance, the manufacturer may specify the number of periods for which a parameter override is valid, the weekly average demand criteria for particular part categories, a percent value which can be used to scale the weekly demand forecast, allowable fluctuations in demand in order to remove aberrations, and/or the number of consecutive times demand may trip filter limits before an override is implemented. It is envisioned that other forecasting parameters may be implemented which impact the calculation of forecast demand. Forecasting parameters are evaluated and applied 46 during the forecasting process.

Next, the demand forecast for each part, including a forecasting error, is calculated 48. For a high volume part, the demand forecast may be based on the prior week forecast and the prior week sales data for a given part. For a low volume part, the demand forecast calculation may be based on previous part sales data over a predetermined demand period (e.g., last thirteen weeks). In a preferred embodiment, a variable response smoothing technique is used to calculate demand forecast. One skilled in the art will readily recognize that other types of averaging techniques may also be used to calculate the demand forecast. In order to more accurately forecast demand, it is also envisioned that different computational techniques may be used for different demand categories. In any event, the demand forecast is expressed as an average weekly demand for each part. In addition, a forecasting error for each part is determined, such that the forecasting error is based on the deviation between prior weeks actual sales and the prior week forecast.

Lastly, the forecasting process may adjust 50 the average weekly demand and/or forecast error for a given part. For example, the system may limit the amount a part's average weekly demand can change within a given period. The average weekly demand for that part is then adjusted within these predetermined constraints. In operation, the forecasting process is preferably run on a weekly basis. The demand forecast output may then be stored for subsequent use by the optimization module 36. Thus, the forecasting process generates demand forecast output which in turn serves as an input to the optimization process.

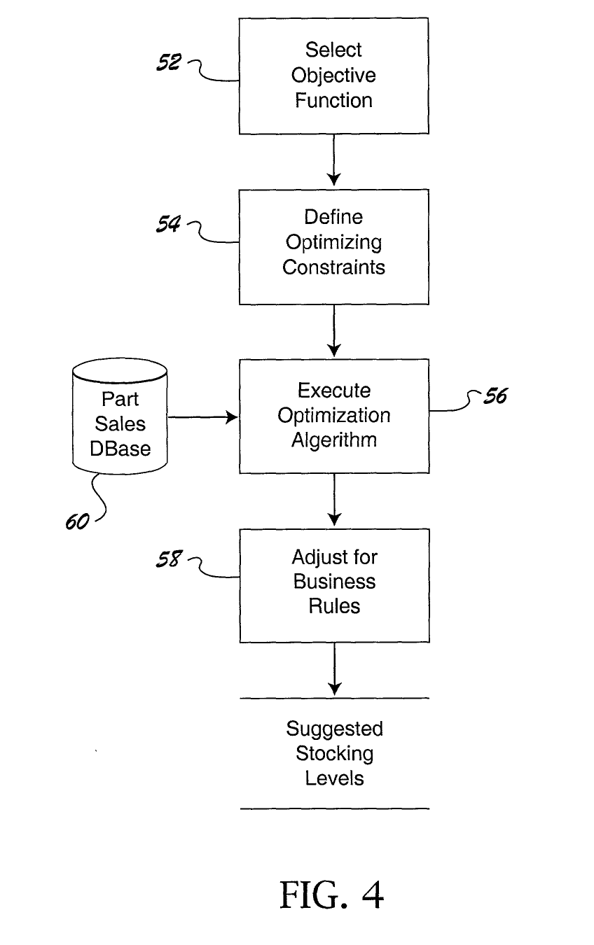

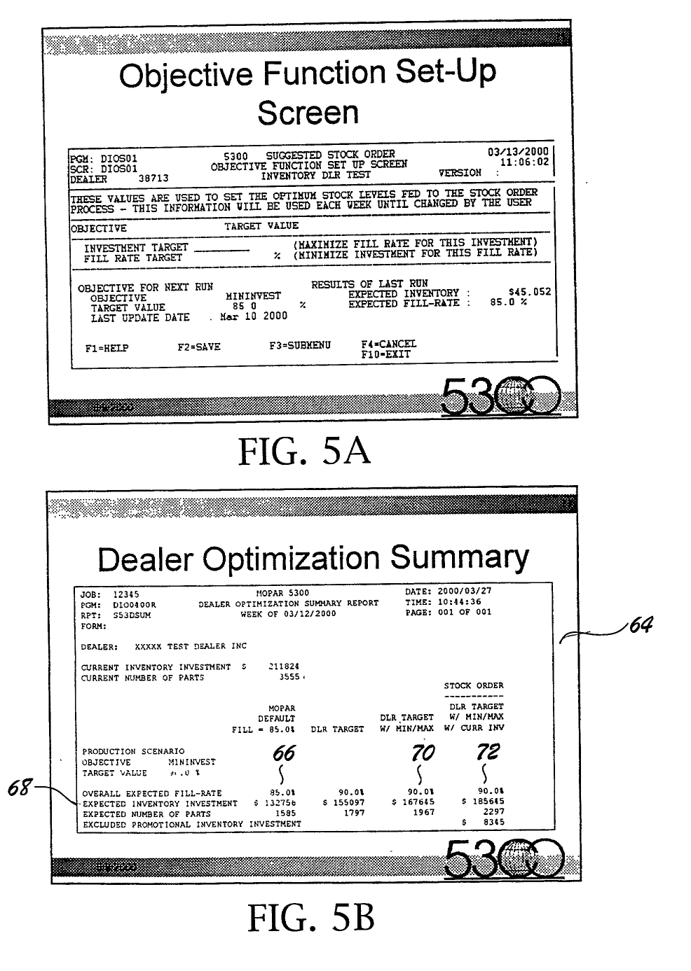

FIG. 4 provides a flowchart for the optimization process as implemented by the optimization module 36. First, a dealer must establish an objective 52 for the optimization process. In a preferred embodiment, two objective functions are available for selection: maximizing overall fill rate or minimizing inventory investment levels. When the dealer selects a particular objective function, the corresponding mathematical expression will be made available to the optimization module 36. To administer the dealer setup process, various user interface screens are provided as part of the inventory management system 20′. An exemplary input screen for entering the objective function is shown in FIG. 5A.

Additionally, the dealer or manufacturer may define optimizing constraints 54 that are to be applied by the optimization module 36. Exemplary constraints may include (but are not limited to) upper and lower bounds on order frequency for a given part, minimum and maximum fill rates for a given part, minimum and maximum overall fill rates for a given part, as well as minimum and maximum inventory investment levels for a given part. It is envisioned that the dealer setup process includes additional input screens (not shown) which allow the dealer to define such optimizing constraints.

The optimization module 36 then executes the optimizing algorithm 56 in view of the selected objective function and any designated optimization constraints. In order to compute the value of the inventory, the optimization module 36 accesses part price data from a part information database 60. One skilled in the art will readily recognize that the optimizing algorithm may be a linear programming algorithm, a mixed-integer programming algorithm, a goal-driven heuristic algorithm, a rules-based algorithm or some other well known optimization algorithm. The output of the optimization module 36 is an optimal part mix recommendation for stocking by the dealer. The optimal order frequency is also calculated for each part.

To perform simulation and “what if” analysis, the optimization process may be executed on demand by the dealer through the dealer workbench 40. In this way, optimization of the dealer's part inventory can be iterative. As noted above, the dealer workbench 40 allows dealers to define the objective of the optimization process and to identify various constraints on the optimization process. Thus, the dealer may compare the results for various sets of optimization constraints before deciding on a final objective target that is to be used in the process.

FIG. 5B illustrates an exemplary output screen 64 for the optimization process. For comparative analysis, four different scenarios are displayed along the bottom portion of the screen. In a first scenario, a minimum overall inventory investment for the dealer is provided at 66 for a given overall fill rate (e.g., 85% fill rate). This first scenario serves as a baseline for the other scenarios. In the second scenario, the dealer's inventory is optimized in view of the objective function selected by the dealer. For instance, given an overall target fill rate, an overall inventory investment is displayed 68 to the dealer. On the other hand, given an overall target inventory investment, an overall fill rate is displayed to the dealer. It should be noted that in this case optimization occurs without honoring the optimization constraints or the existing levels of inventory at the dealership. The third and fourth scenarios are similarly dependent on the objective function selected by the dealer. In the third scenario, the overall inventory investment or the overall fill rate displayed to the dealer at 70 is computed in view of any optimization constraints set by the dealer, but without accounting for the existing levels of inventory at the dealership. In the fourth scenario, the overall inventory investment or the overall fill rate displayed to the dealer at 72 is computed in view of the optimization constraints and the existing levels of inventory at the dealership.

Lastly, the replenishment module 38 generates the ordering parameters using the output from the forecasting module 34 and the optimization module 36. In particular, the forecasted demand for the review time and lead-time periods plus safety stock provides a dynamic order point (i.e., a best re-order point) for each part; whereas the forecasted demand for the lead time and order period plus safety stock provides the dynamic order up to level (i.e., a best stocking level) for each part. These ordering parameters comprise a suggested stocking level for each part. In a preferred embodiment, the replenishment module 38 may further translate the ordering parameters into a suggested part order based on the current inventory of the dealer.

In another aspect of the present invention, at least a portion of the suggested stocking levels for a dealer may account for regional part sales information. An advanced stocking process evaluates part demand in a predetermined geographical area and determines whether there is sufficient demand in the area to warrant stocking of a part by a dealer located in that geographic area. In a preferred embodiment, the advanced stocking process evaluates part demand on a regional basis. A region may be comprised of one or more geographic zones, such that each zone includes at least one vehicle dealer. In this way, a plurality of dealers are typically affiliated with each region.

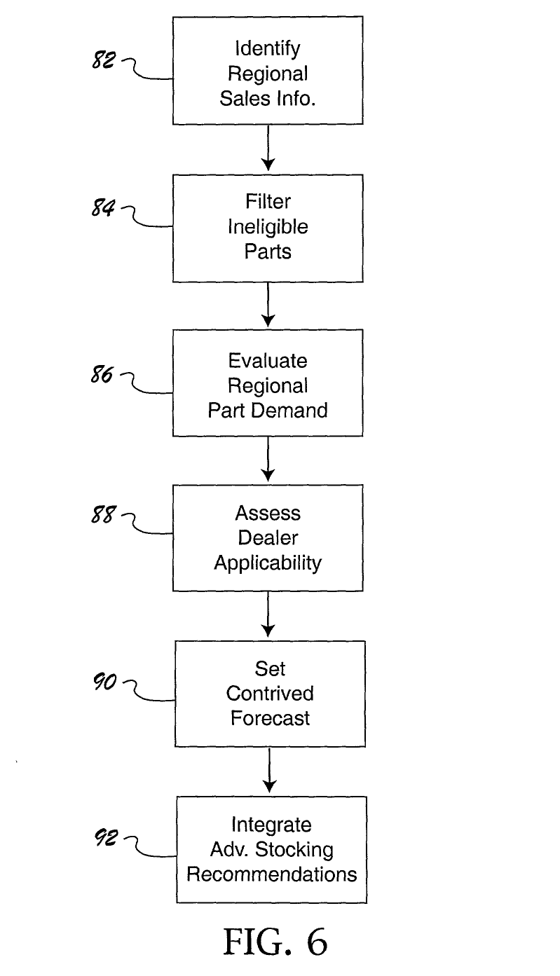

FIG. 6 provides a flowchart for an exemplary advanced stocking process as employed by the inventory part management system 20 of the present invention. The advanced stocking process begins by extracting regional part sales information from the part sales database 24. For each region, all of the part sales occurring over a predefined time period (e.g., the last two weeks) are identified as shown at step 82. To facilitate subsequent processing, the total number of part sales in a given region and the total number of dealers in a given region who accounted for at least one of such part sales are determined for each part. It is to be understood that the advanced stocking process is an iterative process that occurs for each part sold in each region.

However, not all parts are eligible for the advanced stocking process. For example, parts that are too costly may be excluded from the process. In another example, parts that are not returnable to the part supplier may also be excluded from the process. It is envisioned that other types of criteria may be used to filter out parts that are not eligible for the advanced stocking process. In any event, a part filtering process is then applied 84 to the regional part sales information. One skilled in the art will readily recognize from such discussions that if a particular part type fails to meet a given filter criteria, then each of the part sales for this type of part are excluded from subsequent processing.

For each eligible part, regional part sales is evaluated against a regional demand threshold requirement as shown at step 86. The regional demand threshold requirement is a user-defined parameter which is preferably based on empirical data. If the regional part sales for a given part exceeds the threshold requirement, then processing will continue for that given part; otherwise regional part sales for that given part are excluded from subsequent processing.

To provide a more robust assessment of regional part demand, regional part sales may also be evaluated against a regional demand threshold requirement that is based on the size of the dealer. To do so, a regional demand threshold requirement is established for different groupings of dealers, where dealers are grouped according to the size of the dealer. The size of a dealer is preferably based on the total dollar amount of parts purchased over a period of time by the dealer from the parts supplier. However, it is envisioned that other criteria may be used to determine the size of the dealer. In this way, a grouping of large dealers may be assigned a lower regional demand threshold requirement than a grouping of small dealers. In this case, the regional part sales accounted for by a particular grouping of dealers is evaluated against a regional demand threshold requirement corresponding to that grouping of dealers. For processing to continue for a given part, it is envisioned that that part sales for the given part must exceed either (or both of) the regional-level threshold requirement or the dealer size-based threshold requirement. Furthermore, it is envisioned that the regional demand threshold requirement may also be defined at a part level.

Next, the advanced stocking process may assess the appropriateness of recommending a part to a particular dealer in the region as shown at step 88. If a dealer in the region does not currently stock the part, then a recommendation that the part be stocked is provided to the dealer. On the other hand, if the dealer is currently stocking the part, then such a recommendation is not provided to the dealer. Although this assessment is optional, it ensures that a part exhibiting some regional demand is recommended for stocking to those dealers currently not stocking the part.

A particular part is recommended to a dealer via a contrived forecast and forecasting error. The contrived forecast is a demand forecast for the part which accounts for the part's regional demand. In one embodiment, the contrived forecast is set to a user-defined parameter 90 which may be used for each type of part. In this case, the contrived forecast should be set to a level that gives the part a good chance of being stocked at the dealership. It is to be understood that different contrived forecast values may be used for different part categories or for different part types.

In another embodiment, the contrived forecast is a parameter which supplements the demand forecast for the part. In this case the demand forecast value used by the optimizer module 36 is defined as the demand forecast from the forecaster module 34 plus the contrived forecast. It is envisioned that the contrived forecast may be defined in other manners within the scope of the present invention.

The advanced stocking process is a centralized process that primarily occurs on the portion of the inventory management system 20 residing on the manufacture's computing platform 14. In order to communicate advanced stocking recommendations to the dealers, a file is created for each dealer. Each file includes one or more part identifiers as well as their contrived forecast and forecast error. Each file is then transmitted to the appropriate dealer computing platform. In operation, the advanced stocking process is preferably run on a weekly basis.

Lastly, any advanced stocking recommendations sent to a dealer must be integrated 92 into the previously described inventory management process. For instance, as part of the optimization process, the dealer file containing advanced stocking recommendations may be merged with the output from the forecasting module 34. If a part's weekly demand forecast is greater than or equal to the contrived forecast for the part, then contrived forecast is disregarded. However, if a part's weekly demand forecast is less than the contrived forecast, then the contrived forecast and forecast error values will be used in the optimization process. In this way, at least a portion of the suggested stocking levels determined for a dealer may account for regional part sales information.

While the above description constitutes the preferred embodiment of the invention, it will be appreciated that the invention is susceptible to modification, variation, and change without departing from the proper scope or fair meaning of the accompanying claims.

We claim:

1. A computer-implemented method for determining a suggested vehicle part stocking level for a vehicle retailer, comprising the steps of:
receiving from the vehicle retailer at least one of a target fill rate and a target inventory investment;
accessing part demand information for the vehicle retailer;
accessing part cost information; and
determining a suggested part stocking level for the vehicle retailer based on the part demand information and the part cost information in view of the target fill rate or the target inventory investment input by the vehicle retailer.

2. The method of claim 1 wherein the step of accessing part demand information further comprises forecasting average weekly sales data for each part in part based on prior part sales data for the vehicle retailer.

3. The method of claim 2 wherein the step of accessing the part demand information further comprises using a variable response smoothing technique to calculate average weekly sales data.

4. The method of claim 1 wherein the step of accessing the part deamnd information further comprises forecasting average weekly sales data in part based on prior part sales by other vehicle retailers, where the vehicle retailer is located in a geographic area proximate to the other vehicle retailers.

5. The method of claim 1 wherein the step of determining a suggested part stocking level further comprises computing an optimal inventory stocking level and an optimal re-order level for each part.

6. The method of claim 1 further comprising the steps of defining inventory contraints and determining the suggested part stocking level in view of the inventory constraints.

7. The method of claim 1 further comprising the step of translating the suggested part stocking level to a suggested part order for the vehicle retailer in view of current part inventory held by the vehicle retailer.

8. A computer-implemented method for determining a suggested vehicle part stocking level for a given vehicle retailer, comprising:
accessing regional part demand information for a plurality of vehicle retailers residing in a geographic area, where the plurality of vehicle retailers includes the given vehicle retailer;
determining a contrived part demand forecast for at least one part based on the regional part demand information;
accessing part demand information for the given vehicle retailer; and
determining a suggested vehicle part stocking level for the given vehicle retailer based in part on the contrived part demand forecast.

9. The method of claim 8 wherein the regional part demand information is further defined as prior part sales data for each of the plurality of vehicle retailers.

10. The method of claim 8 further comprises determining the contrived part demand forecast for a given part when the regional part demand for the given part exceeds a predetermined regional demand threshold value.

11. The method of claim 10 wherein the regional demand threshold value varies based on the size of the given vehicle retailer.

12. The method of claim 8 wherein the step of determining a suggested part stocking level further comprises using the contrived part demand forecast for a given part when the contrived part demand forecast for the given part exceeds the part demand information for the given part.

13. The method of claim 8 wherein the step of determining a suggested part stocking level further comprises computing an optimal inventory stocking level and an optimal re-order level for each part.
